(19) United States
(12) Patent Application Publication
(10) Pub. No.: US 2020/0227858 A1
(43) Pub. Date: Jul. 16, 2020

(54) Electrical Connector Assembly

(71) Applicant: Appleton Grp LLC, Rosemont, IL (US)

(72) Inventors: Christopher R. Ruhland, Chicago, IL (US); Abhinav S. Sachan, Pune (IN)

(21) Appl. No.: 16/427,204

(22) Filed: May 30, 2019

(30) Foreign Application Priority Data
Jan. 10, 2019 (IN) 201921001094

(51) Int. Cl. H01R 13/52; H01R 13/436; H01R 13/05

(52) U.S. Cl. CPC H01R 13/521; H01R 13/052; H01R 13/436

(57) ABSTRACT

The present disclosure envisages an electrical connector assembly (100) for heavy duty applications. The assembly (100) comprises a plug (10), a receptacle (20), a gasket (50), a first collar (30) and a second collar (40). The collar (30) has external threads and is rotatably mounted on the plug (10). The collar (40) has internal threads complementary to the external threads of the collar (30) and is rotatably mounted on one of the plug (10) and the receptacle (20). The arrangement of collars is configured such that rotation of the collar (40) causes axial displacement of the collar (40) and thereby that of the plug (10) against the gasket (50) for forming a watertight seal between the plug (10) and the receptacle (20). The connector assembly (100) of the present disclosure provides enhanced ingress protection.

### RELATED APPLICATIONS

This Application claims priority to Indian Patent Application No. 201921001094, entitled “An Electrical Connector Assembly” filed on Jan. 10, 2019, the entire contents of which are incorporated by reference herein in their entirety.

### FIELD

The present disclosure relates to the field of electrical connectors.

### BACKGROUND

The background information herein below relates to the present disclosure but is not necessarily prior art.

Heavy duty electrical connectors, i.e., connectors for high voltage and high current applications are bulky and need a highly secure connection between a receptacle (i.e., socket) and a plug. In order to comply with various national and international standards such as NEMA for electrical connectors, ingress protection needs to be provided for such high voltage applications.

Existing heavy duty plugs can come with a locking mechanism such as a plurality of bayonet tabs between the receptacle and the plug for increased security of connection, in addition to a tight fit provided between the mating surfaces. There can also be a rubber gasket provided between the plug and the receptacle to ensure ingress protection. However, with time, gaskets undergo a permanent deformation which involves reduction in thickness of the gasket. Since the locking mechanism locks the plug and the receptacle in a fixed relative position, loss of thickness of the gasket compromises ingress protection. Hence, these gaskets may need to be replaced in every maintenance cycle.

There is, therefore, felt a need of an electric plug which eliminates the shortcomings of the arrangements as described hereinabove.

### OBJECTS

Some of the objects of the present disclosure, which at least one embodiment herein satisfies, are as follows:

An object of the present disclosure is to provide an electrical connector.

Another object of the present disclosure is to provide an electrical connector assembly which is secure.

Yet another object of the present disclosure is to provide an electrical connector assembly which complies with ingress protection standards.

Still another object of the present disclosure is to provide an electrical connector assembly which is easy to connect and lock.

Yet another object of the present disclosure is to provide an electrical connector assembly which has minimum frequency of servicing and part replacement.

Other objects and advantages of the present disclosure will be more apparent from the following description, which is not intended to limit the scope of the present disclosure.

### SUMMARY

The present disclosure envisages an electrical connector assembly. The electrical connector assembly comprises a plug, a receptacle, a gasket, a first collar and a second collar. The plug encloses a first set of conducting elements. The receptacle encloses a second set of conducting elements corresponding to the conducting elements of the first set enclosed by the plug. The gasket is configured to be fitted between the plug and the receptacle. The first collar has external threads and is rotatably mounted on the plug. The second collar has internal threads complementary to the external threads and is rotatably mounted on the receptacle. The arrangement of collars is configured such that rotation of the first collar causes axial displacement of the second collar and thereby that of the plug against the gasket for forming a watertight seal between the plug and the receptacle.

According to an embodiment of the present disclosure, a locking mechanism is provided for preventing axial displacement of the first collar and thereby that of the plug.

According to another embodiment of the present disclosure, the locking mechanism comprises a plurality of tabs formed on the second collar and a plurality of protrusions formed on the receptacle. The plurality of tabs is configured to slide past the plurality of protrusions on rotation of the first collar.

The present disclosure envisages a high-voltage electrical circuit which includes at least one electrical connector assembly as described above.

### LIST OF REFERENCE NUMERALS

100′ Connector assembly of the prior art

30′ Locking collar of prior art

100 Connector assembly of the present disclosure

10 Plug

15 Protrusion

20 Receptacle

25 Tab

30 First collar

14 A surface on plug 10 in contact with first collar 30

34 A surface on first collar 30 in contact with plug 10

35 Threads

40 Second collar

50 Gasket

12 A surface on plug 10 in contact with gasket 50

22 A surface on receptacle 20 in contact with gasket 50

60 Screw

### BRIEF DESCRIPTION OF THE ACCOMPANYING DRAWING

An electrical connector assembly of the present disclosure will now be described with the help of the accompanying drawing, in which:

FIG. 1A is an exploded view of an electrical connector assembly of prior art;

FIG. 1B is an isometric view of a plug of FIG. 1A;

FIG. 2 is a sectional view of the connector assembly of FIGS. 1A and 1B;

FIG. 3 is a plot of torque against number of cycles for the electrical connector assembly of FIGS. 1A, 1B, and 2;

FIG. 4 is a sectional view of an electrical connector assembly according to an embodiment of the present disclosure;

FIG. 5 is an exploded view of an electrical connector assembly according to another embodiment of the present disclosure; and

FIG. 6 is a plot of torque against number of cycles for the electrical connector assembly of FIG. 4.

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a”, “an” and “the” may be intended to include the plural forms as well, unless the context clearly suggests otherwise. The terms “comprises”, “comprising”, “including” and “having” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

When an element is referred to as being “mounted on”, “engaged to”, “connected to” or “coupled to” another element, it may be directly on, engaged, connected or coupled to the other element. As used herein, the term “and/or” includes any and all combinations of one or more of the associated listed elements.

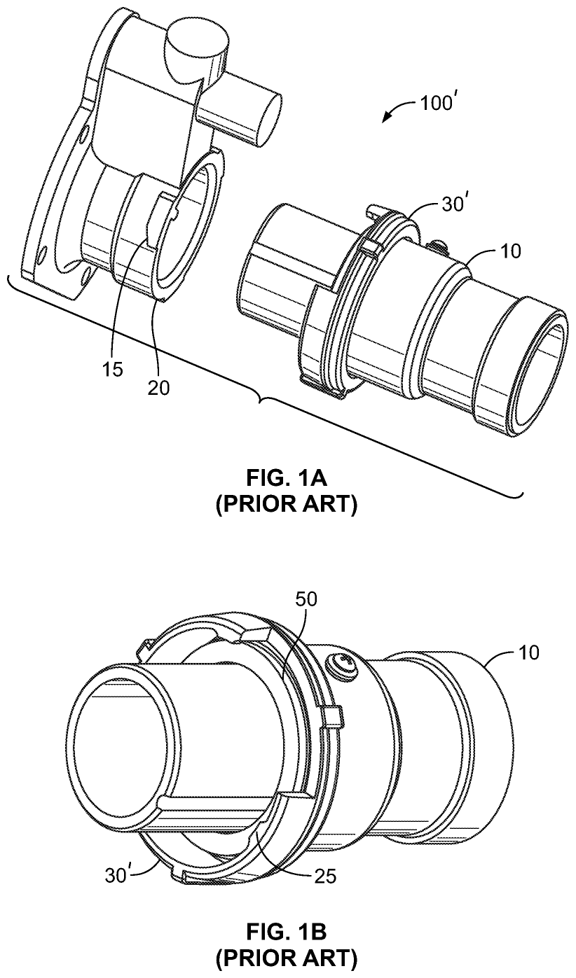

In a heavy duty high-voltage electrical connector assembly 100′ of a prior art, which is shown in an exploded view in FIG. 1A, a plug 10 and a receptacle 20 are brought in a mating configuration by inserting the plug 10 inside a cavity of the receptacle 20. The plug 10 and the receptacle 20 can have complementary key and keyway formations to aid alignment of pairs of conducting elements after the insertion. A locking collar 30′ rotatably mounted over the plug 10 gets inserted past the protrusions 15 formed on front exterior edge of the receptacle 20. Electrical connection between the conducting elements on plug side and receptacle side is established in this configuration. Thereafter, tabs 25′ formed on the locking collar 30′ are angularly displaced past the protrusions 15 to lock the plug 10 with the receptacle 20.

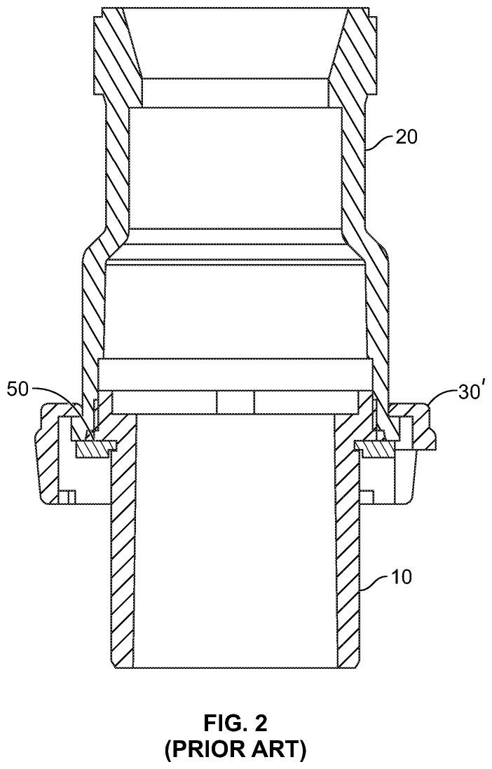

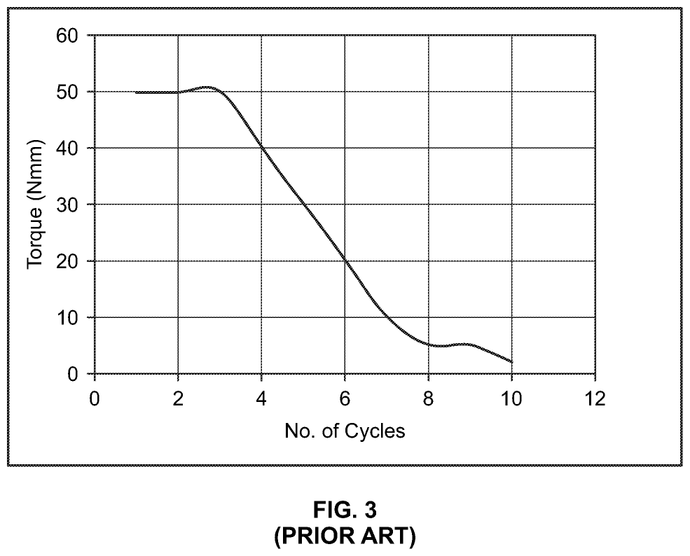

A rubber gasket 50, configured inside the subassembly of the plug 10, is abuttingly disposed between the outer edges of the plug 10 and the receptacle 20. This configuration is shown in FIG. 2. The gasket 50 acts for ingress protection. However, with time, the gasket 50 undergoes a permanent deformation in the form of decrease in thickness. Tightening torque is the reaction torque given by the gasket when the collar 30′ of the electrical connector assembly 100′ is angularly displaced for locking the plug 10 with the receptacle 20. The decrease of tightening torque measured at the point of locking of the plug 10 and the receptacle 20 against progressive duty cycles of the connector assembly 100′ is depicted in the plot of FIG. 3. In the example represented by the plot of FIG. 3, the tightening torque that can be applied against the gasket 50 of a connector assembly 100′ of the prior art drops beyond three duty cycles and by the eighth duty cycle, the tightening torque of the gasket 50 is negligible. The drop in tightening torque is indicative of the decreased sealing capacity of the gasket 50, which increases likelihood of water etc. ingressing into the connector assembly 100′ from outside, since lesser and lesser external pressure of water will cause water ingress into the connector assembly 100′. The connector assembly 100′ of the prior art is not equipped to compensate for this permanent loss in thickness. Ingress protection of the connector assembly 100′ is thus compromised. During the next maintenance cycle, replacing the gasket 50 becomes imperative.

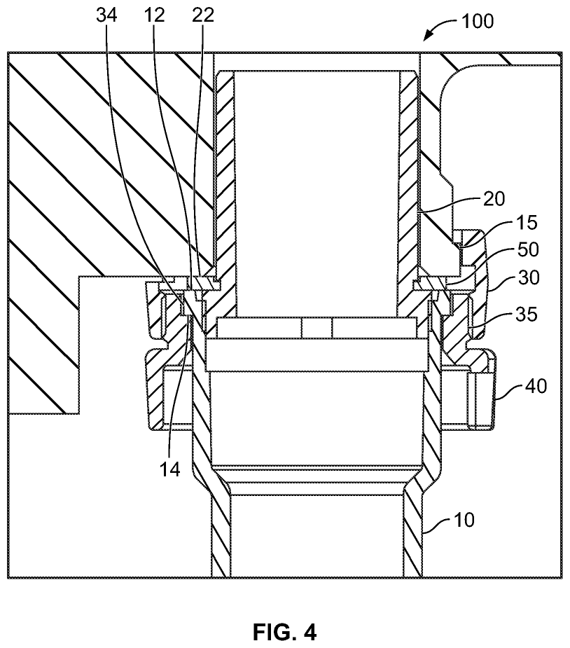

The present disclosure envisages an electrical connector assembly 100, which is shown in a sectional view in FIG. 4. The connector assembly 100 also comprises a plug 10, a receptacle 20, a gasket 50 fitted between the plug 10 and the receptacle 20, a first collar 30 and a second collar 40. The gasket 50 can be disposed in the subassembly of the plug 10 or can be externally inserted. The gasket 50 is made of rubber or any other suitable material with elastomeric properties, such as neoprene rubber, nitrile rubber, silicone and so on. The plug 10, the receptacle 20, the first collar 30 and the second collar 40 is made from a non-conducting material, which can be a moulded plastic such as polycarbonate, polyester, polybutylene terephthalate, polyetherimide, polyamide, polyphenylene sulphide, polypropylene, polyvinyl chloride, epoxyresin, silicone rubber, stainless steel, synthetic resin, neoprene, nylon, liquid crystal polymer and the like. Complementary key-keyway formations are provided between the adjoining surfaces of the plug 10 and the receptacle 20 to aid alignment of pairs of conducting elements. The first collar 30 and the second collar 40 are mounted on the plug 10, or in an alternative embodiment, the first collar 30 is rotatably mounted on the receptacle 20 and a second collar 40 is rotatably mounted on the plug 10. A locking mechanism such as a plurality of protrusions 15 equally spaced apart from each other along the angular direction are provided on the receptacle 20, and tabs 25 are formed on an inner circumferential surface of the first collar 30. After the plug 10 is inserted in the receptacle 20, on angular displacement of the first collar 30, the tabs 25 slide past the protrusions 25 and lock against the operative rear surfaces of the protrusions 15. The extent of angular displacement of the first collar 30 required to achieve this locking configuration is in the range of 30°-40°. In an alternative embodiment, the protrusions 15 are provided on the plug 10, and the second collar 40 is provided with tabs 25 and is rotated to achieve the locking configuration.

According to an aspect of the present disclosure, an exterior cylindrical surface of one collar slides along an interior cylindrical surface of the other collar, as the plug 10 is inserted into the receptacle 20 either in the assembled state of the plug 10 in one embodiment, or in an operative state of the plug 10 and the receptacle 20 in another embodiment. As shown in FIG. 4, a part of the exterior cylindrical surface of the collar 30 slides inside a part of the interior cylindrical surface of the collar 40. According to yet another aspect, complementary threads 35 are formed on the adjacent cylindrical surfaces of the collars 30 and 40. FIG. 4 shows external threads formed on the collar 30 and internal threads formed on the collar 40.

When the plug 10 of the present disclosure is inserted inside the cavity of the receptacle 20, the corresponding conducting elements of both sides are brought into contact, thus completing the electrical connection. Further, the gasket 50 is pressed on one side by the surface 12 of the plug 10 and on the other side by the surface 22 of the receptacle 20.

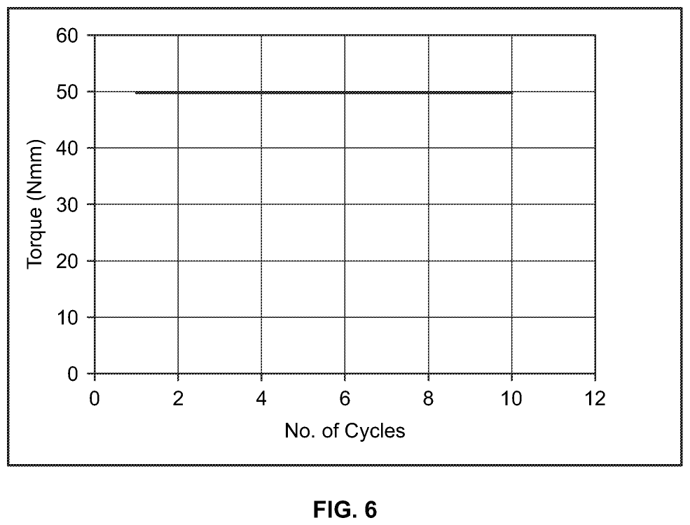

The gasket 50 gets permanently deformed, particularly, compressed along its axial direction due to a combination of creep, fatigue, vibration, thermal stresses or any other physical phenomenon. A gap may be formed between the plug 10 and the receptacle 20 in an extreme case, particularly between surfaces 12 and 22, which needs to be bridged to avoid seepage of water. A fine adjustment is achieved by angular displacement of either the second collar 40 or the first collar 30 in a direction which leads to axial displacement of the second collar 40 inside the first collar 30. Since surfaces 14 and 34 of the plug 10 and the second collar 40 respectively are in contact perpendicular to the axial direction (as shown in FIG. 4), the plug 10 also gets pushed along slidingly, as the second collar 40 screws inside the first collar 30. In the embodiment shown in FIG. 4, the second collar 40 is thus rotated to an extent where surface 22 and surface 12 of the receptacle 20 and the plug 10 again compress the gasket 50 until a desired tightening torque is applied. This arrangement of the gasket 50 ensures sealing of any gap therebetween, thus providing protection against ingress of fluids such as water, gases, dust, dirt and the like. The tightening torque (which is equal to the measured reaction torque) achieved by the screwing mechanism of the first and the second collars of the present disclosure is depicted in FIG. 6. It can be inferred from FIG. 6 that the screwing mechanism provided by threads 35 between the collars 30 and 40 ensures a constant tightening torque over a large number of duty cycles. Hence, life of the gasket 50 is effectively increased by implementing the connector assembly 100 of the present disclosure.

Therefore, the property of ingress protection for the connector assembly 100 is achieved again. Moreover, replacement of the gasket 50 is not required from time to time, or in other words, service life of the gasket 50 is enhanced. A significant cost is thus saved as compared to a connector assembly 100′ of a prior art, such as the one illustrated in FIGS. 1A, 1B, and 2.

Certain heavy duty electrical connectors can be so bulky that the plug 10 may require to be held by both hands for insertion into the receptacle 20. Weight of the plug 10 alone may be 20-30 kg. For such sizes, the construction of connector assembly 100 as described above, which distributes weight between two different collars with one collar on plug side and the other collar on the receptacle side, significantly reduces weight to be carried. The construction described above provides added convenience of tightening the assembly 100 by providing a separate adjustment element in the form of a second collar 40 on the side of the receptacle 20 in accordance with one embodiment.

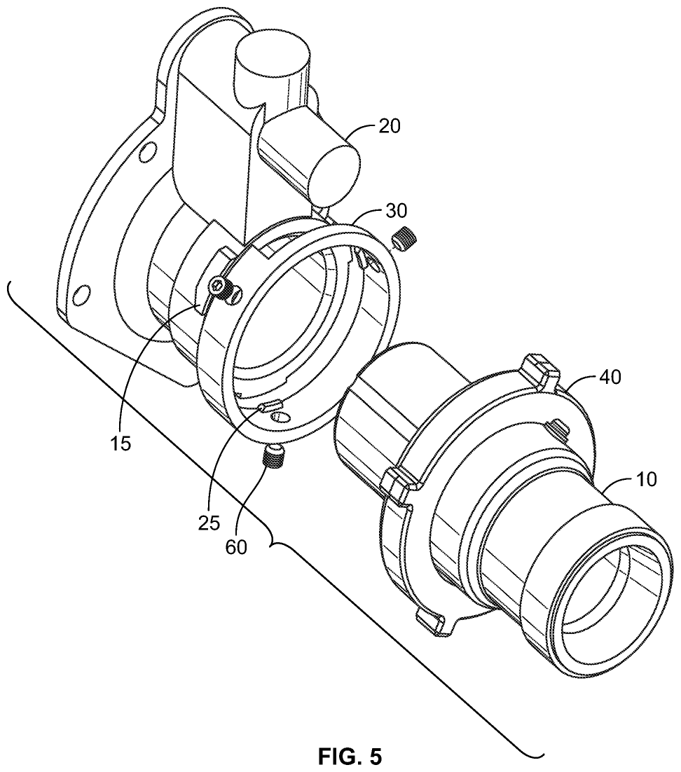

According to another embodiment of the connector assembly 100 of the present disclosure, the second collar 40 is locked in the rotational direction with respect to the receptacle 20, with locking means such as screws 60 as illustrated in FIG. 5. In this embodiment, the first collar 30 is rotatable. The rest of the constructional features, including provision of threads 35 between collars 30 and 40, are the same as described above with respect to FIG. 4. Rotation of the first collar 30 in a suitable direction results in relative motion between the plug 10 and the receptacle 20 along the axial direction, i.e., further sliding of the plug 10 into cavity of the receptacle 20. Therefore, tightening of the assembly 100 by compression of the gasket 50 can be achieved by rotation of the first collar 30.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “inner”, “outer”, “beneath”, “below”, “lower”, “above”, “upper” and the like, may be used in the present disclosure to describe relationships between different elements as depicted from the figures.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### Technical Advancements

The present disclosure described herein above has several technical advantages including, but not limited to, the realization of an electrical connector assembly which:
is secure;
complies with ingress protection standards;
is easy to connect and lock; and
has minimum frequency of servicing and part replacement.

The foregoing disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. An electrical connector assembly (100), comprising:
a plug (10) enclosing a first set of conducting elements;
a receptacle (20) enclosing a second set of conducting elements corresponding to conducting elements of said first set enclosed by said plug (10);
a gasket (50) configured to be fitted between said plug (10) and said receptacle (20);
a first collar (30) having external threads rotatably mounted on said plug (10);
a second collar (40) having internal threads complementary to said external threads and rotatably mounted on one of said plug (10) and said receptacle (20);
said arrangement of collars configured such that rotation of said second collar (40) causes axial displacement of said second collar (40) and thereby that of said plug (10) against said gasket (50) for forming a watertight seal between said plug (10) and said receptacle (20).

2. The electrical connector assembly (100) as claimed in claim 1, wherein a locking mechanism (15, 25) is provided for preventing axial displacement of said first collar (30) and thereby that of said plug (10).

3. The electrical connector assembly (100) as claimed in claim 2, wherein said locking mechanism comprises a plurality of tabs (25) formed on said first collar (30) and a plurality of protrusions (15) formed on said receptacle (20), wherein said plurality of tabs (25) is configured to slide past said plurality of protrusions (15) on rotation of said first collar (30).

4. A high-voltage electrical circuit which includes at least one electrical connector assembly as claimed in any of the claims 1, 2 and 3.
